(19) United States
(12) Patent Application Publication
(10) Pub. No.: US 2022/0247888 A1
(43) Pub. Date: Aug. 4, 2022

(54) UTILIZING A GRAININESS-BASED METRIC TO ESTIMATE A TOTAL COLORANT LIMIT

(71) Applicant: Xerox Corporation, Norwalk, CT (US)

(72) Inventors: Stuart A. Schweid, Pittsford, NY (US); John T. Newell, Fairport, NY (US); Chu-Heng Liu, Penfield, NY (US); Roger L. Triplett, Penfield, NY (US); Mojgan Rabbani, Pittsford, NY (US); Martin S. Maltz, Rochester, NY (US); David A. VanKouwenberg, Avon, NY (US); Seemit Praharaj, Webster, NY (US); Douglas R. Taylor, Webster, NY (US); Martin L. Frachioni, Rochester, NY (US); Paul J. McConville, Webster, NY (US)

(73) Assignee: Xerox Corporation, Norwalk, CT (US)

(21) Appl. No.: 17/166,607

(22) Filed: Feb. 3, 2021

(51) Int. Cl. H04N 1/60; B41J 2/01

(52) U.S. Cl. CPC H04N 1/6061; H04N 1/6033; B41J 2/01

(57) ABSTRACT

A system and method enable determining a total colorant limit for printing images. The system includes memory which stores instructions for: determining a grain value for each of a set of printed patches printed on a first print media, the grain value being based upon a visual contrast sensitivity function computed for the respective patch, the set of printed patches including patches printed on the print media at different total colorant values; determining a total colorant limit for the first print media, as a function of the total colorant values and corresponding grain values for the printed patches in the set, wherein the total colorant limit is a total colorant value which corresponds to a grain value which does not exceed a threshold grain value for the first print media. A processor executes the instructions.

### BACKGROUND

The exemplary embodiment relates to image quality of printed images and finds particular application in connection with a system and method for estimating a total colorant limit for rendering images on a printing device.

Printing devices, such as inkjet printers, use combinations of colorants, such as colored inks, to render images on print media, such as paper. Commonly three or four colorants are provided-cyan, magenta, yellow, and optionally black. In an inkjet printer, the inks are fired on to the print media in small drops, which are quickly dried. For each colored ink, there is an ink limit, which corresponds to the maximum amount of ink which can be applied in each drop. The theoretical ink limit for the printer can be computed by adding the ink limits for all the colorants (excluding any spot colors, which are not used in combination with other inks). However, there are practical limits to the total amount of colorants which can be combined, due to image quality considerations.

In ink jet printers, the image quality is dependent on the paper type used. Paper can affect many types of image quality attributes such as: line quality, gamut, and graininess. An appropriate ink limit may be selected for each paper type to optimize its potential image quality performance. Additionally, there are concerns of printer contamination if the amount of ink used exceeds the ability of the paper to absorb it or for the drying apparatus to fully dry the printed ink. The choice of ink limit for a given paper is the maximum amount of ink that can be effectively dried and neither create any media distortion, nor cause printer contamination. This limit is desirable as it results in maximum color gamut performance. Setting appropriate ink limits is desirable for both the physical interaction with the printer and the image quality attributes. One problem of determining this limit is that it is not directly predictable from such published paper specifications as weight, color, coating, pH, and the like. Even if additional attributes are defined that could allow an estimation of ink that can be effectively dried, problems of image quality may remain. While color gamut may be maximized, other image quality attributes may be adversely affected, such as graininess or edge blur where two colors meet (due to inter-color bleed). Thus, setting ink limits is often a time consuming process of trial and error.

There remains a need for a system and method for estimating an ink limit for a given paper type in an efficient manner.

### INCORPORATION BY REFERENCE

The following references, the disclosures of which are incorporated herein by reference in their entireties, are mentioned.

U.S. Pat. No. 8,870,319, issued Oct. 28, 2014, entitled SYSTEM AND METHOD FOR PRINTING WITH INK LIMITING, by Maltz, et al., describes an inkjet printer and a color profile associated with the printer, which maps a plurality of colors in a device independent color space to a plurality of ink colors formed from a plurality of inks in the printer. The plurality of ink colors only includes colors that are formed with an ink mass density that is below a predetermined threshold.

J. L. Mannos, D. J. Sakrison, “The Effects of a Visual Fidelity Criterion on the Encoding of Images,” IEEE Trans. on Information Theory, Vol. 20, No 4, 525-535 (1974), describes a method for calculating a rate-distortion function of a Gaussian source and simulating the optimum encoding for the Gaussian source, which can be used for encoding of images.

### BRIEF DESCRIPTION

In accordance with one aspect of the exemplary embodiment, a system for determining a total colorant limit for printing images includes memory which stores instructions for determining a grain value for each of a set of printed patches printed on a first print media. The grain value is based on a visual contrast sensitivity function computed for the respective patch. The set of printed patches includes patches printed on the print media at different total colorant values. Instructions are provided for determining a total colorant limit for the first print media, as a function of the total colorant values and corresponding grain values for the printed patches in the set. The total colorant limit is a total colorant value which corresponds to a grain value which does not exceed a threshold grain value for the first print media. A processor executes the instructions.

In accordance with another aspect of the exemplary embodiment, a method for determining a total colorant limit for printing images includes printing a set of printed patches on selected print media, the set of printed patches including patches printed on the print media at different total colorant values; determining a grain value for each of the printed patches in the set of printed patches, the grain value being based upon a visual contrast sensitivity function computed for the patch; and determining a total colorant limit for the first print media, as a function of the total colorant values and corresponding grain values for the printed patches in the set, wherein the total colorant limit is a total colorant value which corresponds to a grain value which does not exceed a threshold grain value for the first print media.

One or more steps of the method may be performed with a processor device.

In accordance with another aspect of the exemplary embodiment, a system for applying a total colorant limit for printing images includes an inkjet printer which includes a plurality of colorant stations. Each of the colorant stations applies a respective colorant to print media in accordance with printing instructions. A computing device is in communication with the printer. The computing device computes a total colorant limit for the plurality of colorant stations as a function of a computed grain value for each of a set of test patches printed on the print media by the colorant stations.

### BRIEF DESCRIPTION OF THE DRAWINGS

FIG. 1 is a functional block diagram of a system for determining and applying a colorant limit for printing images in accordance with one aspect of the exemplary embodiment;

FIG. 2 is a functional block diagram illustrating exemplary software components of the system of FIG. 1;

FIG. 3 illustrates an example test pattern for use in the system of FIG. 1;

FIG. 4 illustrates an example visual contrast sensitivity function (CSF) for use in the system of FIG. 1;

FIG. 5 is a flow diagram illustrating a method for determining and applying a colorant limit for printing images in accordance with another aspect of the exemplary embodiment; and

FIG. 6 illustrates a plot of grain value vs total ink usage in nl/mm² for a set of printed patches on the same print medium.

### DETAILED DESCRIPTION

Aspects of the exemplary embodiment relate to a system and method which use graininess performance of a given paper to determine an appropriate total colorant (e.g., ink) limit to set for a given paper stock. The total colorant limit is determined as a function of a measure of the graininess (grain value) of test patches printed at different total colorant values. In particular, the total colorant limit is selected from the function such that a corresponding grain value is visually acceptable, e.g., does not exceed a threshold on grain value, which is based on human observations.

As used herein, a “printer” can include any device for rendering an image on print media, such as a copier, laser printer, bookmaking machine, facsimile machine, or a multifunction machine (which includes one or more functions such as scanning, printing, archiving, emailing, and faxing). “Print media” can be a physical sheet of paper, plastic, or other suitable physical print media substrate for images which is capable of being passed through the printer. A “print job” is normally a set of electronic page images, from a particular user, or otherwise related. A “page image” generally may include information in electronic form which is to be rendered on the print media by the printer and may include text, graphics, pictures, and the like. The operation of applying images to print media, for example, graphics, text, photographs, etc., is generally referred to herein as printing or marking.

Page images may be received by the system in any convenient file format, such as JPEG, GIF, JBIG, BMP, TIFF, or the like or other common file format used for images and which may optionally be converted to another suitable format prior to processing. The page images can be input from any suitable image source, such as a workstation, database, memory storage device, such as a disk, or the like. The images may be individual images, such as photographs, graphics or text, or combined images which include photographs along with text, and/or graphics, or the like. In general, each input page image includes image data for an array of pixels forming the image. The image data may include colorant values, such as grayscale values, for each of a set of color separations, such as L*a*b*, RGB, or CMYK, or be expressed in another color space in which different colors can be represented, which may be converted to suitable printer-specific colorant values, such as CMYK.

“Total colorant value” is a sum of the amount of each of a set of colorants used, per unit area of a print medium and can be expressed, for example, as total colorant (e.g., ink) usage (in volume/unit area) or total area coverage (expressed as a percentage, which sums the area coverage of the colorants used).

“Total colorant limit” is a limit established for the total colorant value and can be expressed, for example, as a total colorant (e.g., ink) coverage limit (TIC limit) or a total colorant (e.g., ink) usage limit (TIU limit). In the exemplary embodiment, the total colorant value is constrained so that it does not exceed the established total colorant limit for a given print medium.

In the following, reference is generally made to inks as the colorants, paper as the print medium, and an inkjet printer as the printer. However, it is to be appreciated that the system and method are not limited to this embodiment.

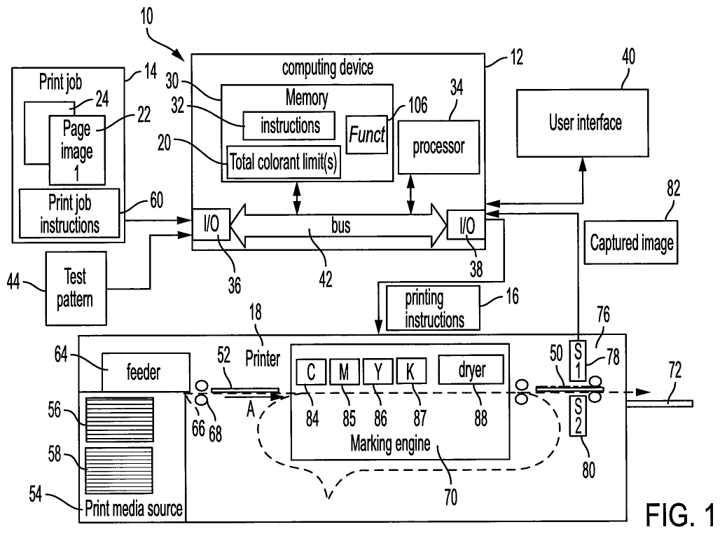

With reference to FIG. 1, a system 10 for determining and applying a total colorant limit for printing images includes a computing device 12 (such as a digital front end), which receives a print job 14 to be printed. The computation device 12 outputs printing instructions 16 to one or more printers 18, in which a computed total colorant limit 20 has been applied during processing of page images 22, 24 of the print job 14 on a specified print media.

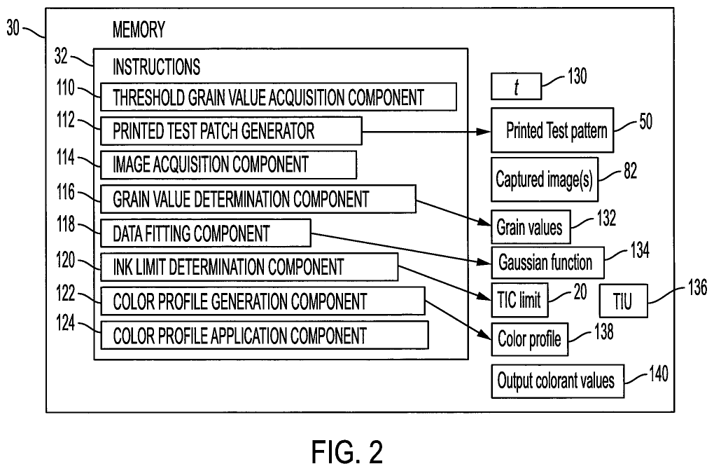

The computing device 12 includes memory 30, which stores software instructions 32 for performing a method as described below with reference to FIG. 2. A processor 34, in communication with the memory 30, executes the instructions 32. Exemplary instructions are discussed below, with reference to FIG. 2. The computing device 12 also includes one or more input/output (I/O) devices 36, 38, for communicating with external devices, such as a source of the print job (not shown), the printer 18, and optionally a user interface 40. Hardware components 30, 34, 36, 38 may be communicatively connected by a data/control bus 42. A test pattern 44, may be stored in memory 30, to be used in determining the total colorant coverage limit for specified print media types.

The printer 18 can be any device for printing images 50, such as test patterns and other page images, on sheets 52 of print media, such as paper sheets, using colorants, such as inks or toners. In the illustrative printer 18, a source 54 of print media sheets 52 is configured for supplying two or more different types of paper from respective stacks 56, 58. Print job instructions 60, included in or otherwise associated with the print job 14, are used to identify the type(s) of print media, or the stack(s) 56, 58 from which sheets of paper is/are to be drawn, during printing of the print job 14. In the illustrated embodiment, the total colorant limit 20 for each type of paper may be different, for example, due to differences in the weight of the sheets or other sheet properties which affect image quality. The total colorant limit 20 can be expressed, for example, as a total ink coverage limit or a total ink usage limit.

A sheet feeder 64 feeds sheets 52 of print media singly onto a print media path 66. A conveyor system 68 conveys the sheets 52 along the path 66, downstream in the direction of arrow A, to a marking engine 70 and ultimately to a sheet output device 72, such as a tray. The conveyor system 68 may include a combination of sheet moving devices, such as rollers, conveyor belts, air jets, and the like. For duplex printing, a return loop 74 may return the printed sheet to the marking engine 70.

A sensor system 76, including one or more full width array scanners 78, 80, or other image capture devices, is positioned to capture images 82 of the printed sheets, specifically, images of printed images 50 generated from the test pattern 44.

The illustrated marking engine 70 includes a plurality of stations 84, 85, 86, 87 for applying respective colorants, such as inks or toners to the sheet for forming a printed image 50. A dryer 88 (or set of dryers) helps to dry the printed image 50 onto the sheet 52. In one embodiment, each of the stations includes a set of ink jets which fire droplets of ink onto the sheet in accordance with the printing instructions 16. While four stations 84, 85, 86, 87 are shown, for cyan, magenta, yellow, and black, respectively, fewer or more stations may be employed. For each station, a respective ink (colorant) limit is governed by the maximum possible amount of ink the station can apply—the full-tone ink coverage limit, which is equated to 100%. The maximum possible colorant is the sum of the percentages, i.e., 400% in the case of four colorants. The total ink coverage (TIC) limit 20 is no more than the maximum possible sum of the inks, and is generally less than the maximum, for at least some of the paper types. E.g., for one paper type, the TIC limit 20 could be 320% for four colorants, while for another, it could be 300% or 400%. Accordingly, when the computing device 12 determines that colorant values would, in total, exceed the total colorant limit 20 for the paper type, modified colorant values are computed, which, in total, do not exceed the TIC limit 20.

In the exemplary system 10, the TIC limit 20 for a given print media type is computed based on graininess, expressed as a grain value G. The grain value G is computed for printed images 50 of the test pattern 44, that have been printed on sheets 52 of the respective print media 56, 58 to be used in the printer 18. It has been observed that, as the ink usage increases, the graininess of the saturated secondary and tertiary colors increases commensurately. This increase in graininess is a function of the inter-color ink interaction and the ink/media interaction. Graininess can be severe for certain paper types (such as gloss coated) and this can also lead to printer contamination. This, in turn, can reduce image quality.

Graininess affects image quality when it reaches a level at which it is noticeable to the human eye. In particular, the eye is able to differentiate printed dots which exceed a certain size, rather than seeing a continuous color. While this threshold can vary from human to human, and is dependent, to some degree, on illumination, an acceptable level of graininess t can be determined by having a set of observers look at printed test patterns under the same illumination. In the exemplary embodiment, a total ink coverage limit is chosen that results in acceptable graininess performance. This ensures both acceptable image quality and a low probability of machine contamination. The TIC limit is then used in the creation of a color profile, which is used to compute colorant values for each of the color separations.

In the exemplary embodiment, therefore, graininess is used as a proxy for the amount of ink a paper can effectively handle without degrading image quality.

To take advantage of this correlation between image graininess and irregular ink flow caused by complicated ink-ink and ink-substrate interactions, a test pattern 44 is created and may be stored in memory 30. In particular, a set of secondary and tertiary colors (to be formed from mixtures of two or three colorants) is selected to form the test pattern 44. The colors chosen are sensitive to ink amount change and typically exhibit a fairly high visual graininess. For example, a typical color will include all halftone (mid-tone) C, M, and Y primaries. Colors with solid primaries are avoided. The set of colors chosen may represent a significant number of two-color and three-color combination/interactions. As a result, this set of colors can provide a balanced IQ assessment of all the colors.

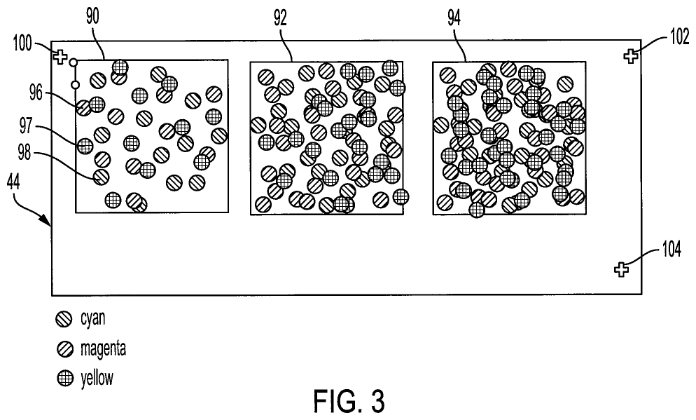

As illustrated in FIG. 3 (not to scale) the test pattern 44 may include a set of test patches 90, 92, 94, etc., each test patch including an array of dots 96, 97, 98, of a selected color (or all colors) to be printed to achieve a desired total ink usage (or coverage) per patch. Rather than the dots being aligned on a grid, each test pattern patch can be a stochastic screen of dots where the distances between dots vary in a pseudo-random distribution, for each color.

In one embodiment, the set of patches sample the color space of secondary and tertiary colors at varying total ink coverage (TIC) amounts (or corresponding total ink usage (e.g., measured as a volume or weight) per unit area of print media (TIU)). In this embodiment, halftone dots 96, 97, 98 in patches 90, 92, 94 and are of the same size but with different density. The test pattern 44 may also include a set of three or more fiducial marks 100, 102, 104, to be used in mapping the printed image 50 to the test pattern 44 for identifying the locations of each of the patches 90, 92, 94, etc. In other embodiments, some of the dots 96, 97, 98, etc. may be used as fiducial marks. Each test patch 90, 92, 94 is associated in memory 30 with a respective total ink usage, e.g., expressed in nanoliters/square millimeter, i.e., the estimated total amount of ink which will be applied to generate the printed patch. As an example, the patch TIU may span a range of about 3.5 to 7.5 nl/mm², but other ranges may be suited to different printers. The TIC (expressed as a percentage) is correlated with TIU (expressed as an ink amount/unit area).

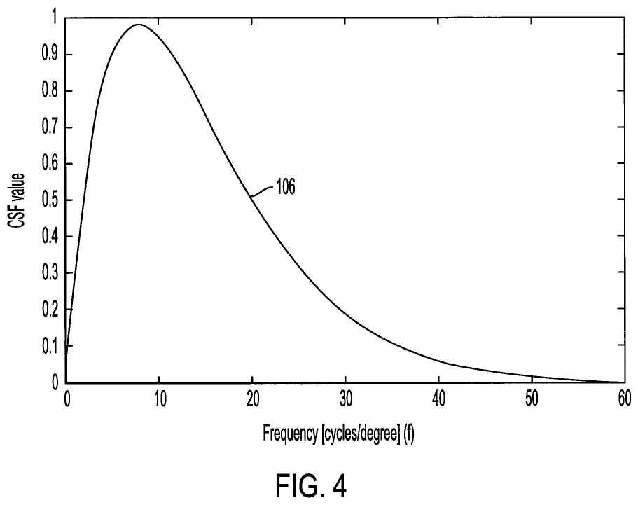

To estimate graininess, a grain value G is computed for each patch that is based upon a visual contrast sensitivity function (CSF) 106. A CSF is computed on the captured image 82 of a set of printed patches corresponding to test patches 90, 92, 94, etc. Conventionally, CSFs have been used to measure the visual response to line pairs at various frequencies. This has been useful in determining the eye's response to printing halftone frequencies and repeatable printer artifacts (e.g., banding), among others. There are several versions of the contrast sensitivity function, which plot a CSF amplitude A(f) as a non-linear function of a single variable, f, which is the frequency in cycles/degree of the eye's field of vision. FIG. 4 shows an example contrast sensitivity function 106. The analytic form of the CSF can be represented by Equation 1:

A(f)=2.6(0.0192+0.114f)exp^{-(114f})^{1.1} (1)

See, Mannos and Sakrison, discussed above. This form of the CSF has a simple analytic form for implementation. For the present application, it has been found to provide a good estimate of perceptual acceptability. However, it is to be appreciated that other non-linear transfer functions for computing a CSF value as a function of frequency f may alternatively be used. Such other functions may take into consideration other parameters, in addition to frequency, such as degree of ambient lighting, but by keeping the other parameters at (fairly) constant values, they can be ignored for purposes of the present method.

As can be seen from FIG. 4, the eye is most sensitive to frequencies of about 10 cycles (in this example, lines) per degree, at equal contrast, and progressively becomes less sensitive as the frequency increases. At some point, e.g., at around 40 cycles/degree, the eye is unable to distinguish between the lines and sees a smooth color.

The same principle is applicable to halftone dot frequencies. In halftone printing, for each colorant, each point is printed with an ink dot or is not printed. To compute a grain value of a printed test patch containing a distribution of printed dots, the CSF in two directions can be computed. For each patch printed, the grain value can then be computed as an integrated power function of a contrast sensitivity function of pairs of frequency components, according to Equation 2:

Grain value of patch

$$G = {\{ {\sum }_{f 1} {\sum }_{f 2} {[ {patch}_{fft ( f 1 , f 2 )} * A ( {( {f}_{1}^{2} + {f}_{2}^{2} )}^{0.5} ) ]}^{2} \}}^{0.5} \qquad ( 2 )$$

f1 and f2 are the horizontal and vertical frequency components that span the process and cross process direction. The sum over possible values Σ_{f1}Σ_{f2} is used in the case of a stochastic screen to reflect that the frequency components in X and Y directions have a diffuse amplitude across the 2-D frequency plane. If the screen is generated as a base pattern with random components, some frequencies will be more present than others.

The patch_{fft(f1,f2)} is a two dimensional Fast Fourier Transform (FFT), which spans the f1 and f2 space, and determines each frequency component's contribution. A two-dimensional N×N fft has N f1 frequency buckets along one axis and N f2 frequency buckets along the other. For dots arranged on a regular grid, the only non-zero amplitudes occur at f1=[K1/d1, k2/d2], where d1 and d2 are the distances between dot centers in X and Y directions and k1 and k2 are integer values. For a truly random screen, f1 and f2 can take on all values. In the case of a stochastic screen many (if not most) f1, f2 frequency component combinations will have a non-zero amplitude.

More generally, the patch_{fft(f1,f2)} represents the two-dimensional lightness response of the patch (e.g., L* in the L*a*b* color space). Other methods of computing an overall lightness measure of the patch are also contemplated.

The contrast sensitivity function, A((f₁²f₂²)^{0.5}) is square root of the sum of a pair of horizontal and vertical frequency components computed according to Eqn. 1 for process and cross process directions of the printed patch, i.e.,

$$A ( {( {f}_{1}^{2} + {f}_{2}^{2} )}^{0.5} ) = 2.6 ( 0.0192 + 0.11 \; 4 {( {f}_{1}^{2} + {f}_{2}^{2} )}^{0.5} {exp}^{- {( 0.114 {( {f}_{1}^{2} + {f}_{2}^{2} )}^{0.5} )}^{1.1}}$$

More generally, the visual contrast sensitivity function can be expressed in the general form:

$$A ( {( {f}_{1}^{2} + {f}_{2}^{2} )}^{0.5} ) = x ( y + {z ( {f}_{1}^{2} + {f}_{2}^{2} )}^{0.5} {exp}^{- {( {z ( {f}_{1}^{2} + {f}_{2}^{2} )}^{0.5} )}^{n}} ,$$

or a function thereof, where x, y, z and n are each values greater than 0.

After using Eqn. (2) to calculate a grain value G for every patch, the set of data mapping total ink usage amounts (TIU) to grain values G can be used to generate a function that predicts grain value as a function of TIU, which can be used to identify a TUI which does not exceed a threshold grain value t, as described in further detail below.

With reference to FIG. 2, the software instructions 32 may include a threshold grain level acquisition component 110, a printed test patch generation component 112, an image acquisition component 114, a grain value determination component 116, a data fitting component 118, an ink limit determination component 120, and a color profile generation component 122.

Briefly, the threshold grain value acquisition component 110 acquires a threshold grain value t 130, which is based on human observations. The threshold grain value t is considered to be a maximum acceptable grain value.

The printed test patch generation component 112 causes the test pattern 44 to be printed by a selected printer 18, to produce a printed image 50 of the test pattern on a sheet 52 of a selected print media.

The image acquisition component 114 acquires a captured image 82 of the printed image 50 from the sensor system 76.

The grain value determination component 116 computes the grain value G of each patch 90, 92, 94, etc. in the captured image, e.g., using Eqn. 2. The set of computed grain values 132 is stored in memory.

The data fitting component 118 fits a function 134, such as a Gaussian mixture function (a sum of Gaussian functions, each having a mean and variance), to a plot of the computed grain value G vs computed ink usage TIU for each patch.

The ink limit determination component 120 uses the function 134 to identify a total ink usage limit 136, which corresponds to the threshold grain value t 130. Component 120 may convert the total ink usage limit 136 to a total ink coverage (TIC) limit 20.

The color profile generation component 122 generates a color profile 138, which takes input colorant values for an image 22 to be printed and computes output colorant values for the four colorants which, when summed, do not exceed the total colorant coverage limit 20 determined for the print media.

The computing device 10 may include one or more computing devices, such as a desktop, laptop, or palmtop computer, portable digital assistant (PDA), server computer, cellular telephone, tablet computer, pager, combination thereof, or other computing device capable of executing instructions for performing the exemplary method.

The memory 30 may represent any type of non-transitory computer readable medium such as random access memory (RAM), read only memory (ROM), magnetic disk or tape, optical disk, flash memory, or holographic memory. In one embodiment, the memory 30 comprises a combination of random access memory and read only memory. In some embodiments, the processor 34 and memory 30 may be combined in a single chip. Memory 30 stores instructions for performing the exemplary method as well as the processed data.

The interface(s) 36, 38 allow(s) the computer to communicate with other devices, e.g., via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 34, in addition to executing instructions 32 may also control the operation of the computing device 12 and printer 18.

The user interface 40 may include a display device and one or more user interface devices, such as a touch screen, keypad, keyboard, cursor control device, or combination thereof. A user of the printer may use the user interface to initiate the method for identifying a total ink coverage limit 20 when a new paper stock is to be used in the printer 18, or at other times, for example, if a new type of ink is being used or when the print speed or dryer temperature is/are modified. In other embodiments, the method may be implemented by the printer sending a signal to the computer to indicate that a new print medium has been installed in one of the stacks. The computer may initiate the method automatically, or provide the user with an option, via the user interface, to select another time for performing the total ink limit determination method.

The term “software instructions,” as used herein, is intended to encompass any collection or set of instructions, executable by a computer or other digital system, so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

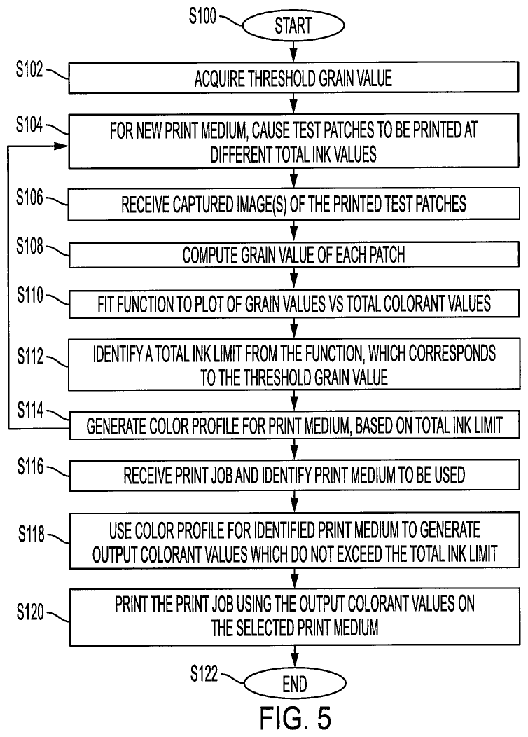

With reference to FIG. 5, a method for computing an ink limit 20 for a selected print media is shown. The method may be implemented with the system of FIG. 1. The method begins at S100.

At S102, a threshold grain value t 130 is acquired, by the threshold grain value acquisition component 110. The threshold grain value t may be acquired for each print medium to be used in the associated printer 18. To set the threshold, a pool of experts or a pool of other human observers may be used. The observers view printed sheets/test patches with different grain values (computed according to Equation 2, in a similar manner to that described below for S108). An average threshold t is computed (e.g., a mean or mode of the observers' decisions). This step can be performed offline and needs only to be performed once. In one embodiment, the threshold grain value t 130 is input via the user interface 40.

At S104, test patches 90, 92, 94 are printed with different colorants mixtures at different levels of ink usage. This may include sending the test pattern 44 to the associated printer 18, by the printed test patch generation component 112, to produce a printed test pattern image 50 of the test pattern on one or more sheets 52 of a selected (first) print medium. S104 may be repeated for a second, or subsequent, print media type(s) that is/are expected to be used in the printer. Multiple sheets may be printed for each type of print media. The test pattern 40 includes multiple (e.g., at least 50) multi-separation test patches 90, 92, 94 employing different total ink usage amounts. The set of patches in the test pattern 50 thus sample the color space of secondary and tertiary colors at varying total ink usage/coverage amounts.

At S106, an image 82 of the printed test pattern/patches is captured, by the sensor system 76, and the captured image is acquired and stored in memory by the image acquisition component 114.

At S108, the grain value G of each patch 90, 92, 94, etc. in the captured image is computed, by the grain value determination component 116, as an integrated CSF weighting of the variation power, e.g., using Eqn. 2. In this step, the patches in the captured image 82 are first identified, e.g., by mapping fiducial marks in the captured image 82 to the corresponding fiducial marks 100, 102, 104 in the test pattern and then mapping regions of the captured image 82 to respective patches in the test pattern. The minimum distances d₁ and d₂ between centers of pairs of adjacent dots (pitch) in each patch are determined in mutually perpendicular directions and corresponding frequencies f₁ and f₂ computed as the inverse of d₁ and d₂, respectively. The values of f₁ and f₂ are plugged into Eqn. 2 to compute G. The set of grain values 132 is stored in memory.

At S110, a function 134, such as a Gaussian mixture function, is fitted to a plot of the computed grain values vs total ink usage for the patch, by the data fitting component 118. Gaussian regression may be used to fit a smooth curve 134 to the ink usage (TUI) vs graininess (G) data. The Gaussian mixture function 134 that is fitted to the data may be constrained to be monotonic with a minimum slope to ensure that the inversion is numerically stable. Gaussian regression (a form of machine learning) is a useful method for curve fitting in that it does not require an a-priori functional form to be defined. Rather, the regression algorithm identifies a mean and standard deviation of a Gaussian function, or, more generally, a sum of Gaussian functions, which best fits the data. Using Gaussian regression to fit the color space has advantages over setting a maximum grain value or choosing a grain value which covers 95% (or other percentage) of the chosen patch set. However, other methods such as these are also contemplated. Additionally, Gaussian regression is insensitive to measurement noise, which may be considerable in this case, as there may be large variations in graininess for similar ink usage. The noise is predominately caused by different primaries interacting differently with each other and the human eye being more sensitive to some primaries than others. In some embodiments, to address this at least partially, grain value thresholds t may be acquired at S102 for a plurality of combinations of primary colors and used with respective grain values vs ink usage plots. For example, one plot could be used when cyan is the highest component, another when magenta is the highest component, and so forth.

In some embodiments, the curve 134 fitted to the ink usage (TUI) vs graininess (G) data may be displayed to a via the user interface 40 for validation.

At S112, a total ink usage TIU 136 is identified from the Gaussian mixture function, which corresponds to (or does not exceed) the threshold grain value t 130, by the ink limit determination component 120. In particular, the curve obtained at S110 may be inverted to find the TIU 136 which produces the maximal acceptable grain value t. The total ink amount 136 is converted to a total ink coverage limit 20 for color management profile creation. The ink limit is the total amount of ink (TIU) used when the graininess is at the threshold divided by the maximum amount of ink used. For example, if the maximum ink is determined to be 5 picoliters/mm² and each primary (C,M,Y,K) at 100% coverage is 3.5 pl/mm² then total ink coverage limit 20=(5/3.5) or 147%.

At S114, a color profile 138 is generated by the profile generation component 122, based, at least in part, on the total ink coverage limit. This includes, for each color that exceeds the total ink coverage limit 20, reducing the values of one or more of the component colorants such that the total ink coverage limit is not exceeded, while providing a similar output color. Several algorithms are available for converting a color which exceeds the TIC limit 20 to a set of colorant values which, in combination, do not exceed the TIC limit. In some embodiments, a user may be permitted to adjust the TIC limit 20 via the user interface 40. The method may return from S114 to S104 when a new (second) print medium, for which no TIC limit has been stored, is identified.

At S116, a print job 14 is received and input colorant values are determined for printing each image 22. The print media type for printing the image is identified, e.g., based on the print job instructions 60.

At S118, the input colorant values are input to the color profile 138 for the selected print medium to generate output colorant values 140 for the four colorants which, when summed, do not exceed the total colorant coverage limit 20 determined for the print media type.

At S120, the processed print job is sent to the printer 18 to be printed using the output colorant values 140.

The method ends at S122.

The method illustrated in FIG. 5 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 12 (for example, an internal hard drive of RAM), or may be separate (for example, an external hard drive operatively connected with the computer 12), or may be separate and accessed via a digital data network such as a local area network (LAN) or the Internet (for example, as a redundant array of inexpensive or independent disks (RAID) or other network server storage that is indirectly accessed by the computer 12, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 5, can be used to implement the method for computing and using the grain value-based total colorant (ink) limit 20. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

By way of example, the exemplary method is used to determine a total colorant limit for a particular print media to be used in a selected inkjet printer. A maximum acceptable grain value t is determined from a set of observers rating acceptability and/or predicting customer acceptability. The total ink coverage limit 20 is then chosen to ensure that the graininess produced during printing is at or below the acceptable grain value limit t.

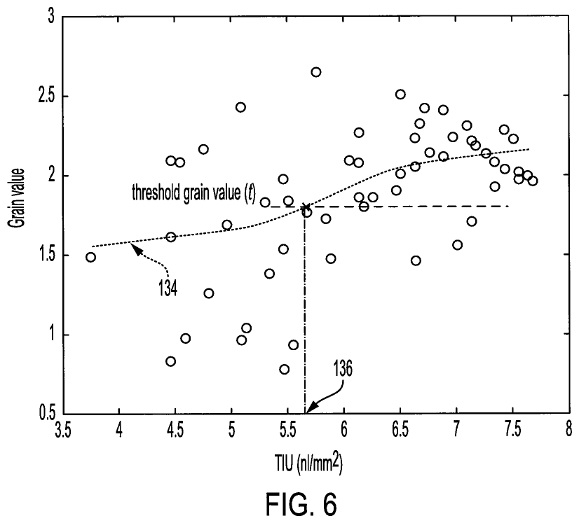

FIG. 6 shows the raw data (each circle represents a respective patch) and a curve fit of the grain value vs ink usage for a given paper type. There is large variation in the data, as expected, but it can be seen that a smooth global weighted fit through color space is produced using Gaussian regression. For this example, if the acceptable average grain value t is 1.8 then the total ink coverage limit for this paper may be set at 5.7 nl/mm².

The use of grain value to establish an ink limit for print media has several advantages. These may include:

1. Using grain value as a proxy for limits on ink drying and printer contamination limits.

2. Using an image quality attribute to ensure image quality is preserved rather than solely ensuring that ink drying physical limits are adhered to.

3. Using CSF as a graininess metric shows an improvement over standard deviation of L*.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system for determining a total colorant limit for printing images, comprising:
memory which stores instructions for:
determining a grain value for each of a set of printed patches printed on a first print media, the grain value being based upon a visual contrast sensitivity function computed for the respective patch, the set of printed patches including patches printed on the print media at different total colorant values; and
determining a total colorant limit for the first print media, as a function of the total colorant values and corresponding grain values for the printed patches in the set, wherein the total colorant limit is a total colorant value which corresponds to a grain value which does not exceed a threshold grain value for the first print media; and
a processor which executes the instructions.

2. The system of claim 1, further comprising instructions for:
receiving a print job to be printed, the print job including at least one page image; and
computing colorant values for printing pixels of the at least one page image, wherein the colorant values are computed such that they do not exceed the total colorant value.

3. The system of claim 1, further comprising:
a printer which prints the set of test patches on one or more sheets of the first print media.

4. The system of claim 1, further comprising:
a sensor system which captures an image of the printed test patches, the grain value being determined from the captured image.

5. The system of claim 1, wherein the determining of the grain value comprises computing an integrated function of the visual contrast sensitivity function computed for a respective pair of frequency components determined for the printed test patch, each frequency component in a pair representing a frequency of halftone dots in a respective direction.

6. The system of claim 5, wherein the integrated function is also a function of a lightness of the respective patch.

7. The system of claim 1, wherein the determining of the grain value comprises computing a grain value according to:
Grain value of patch
$$G = {\{ {\sum }_{f 1} {\sum }_{f 2} {[ {patch}_{fft ( f 1 , f 2 )} * A ( {( {f}_{1}^{2} + {f}_{2}^{2} )}^{0.5} ) ]}^{2} \}}^{0.5} ,$$
where the patch_{fft(f1,f2)} is a fast Fourier transform (fft) of the two-dimensional lightness response of the patch and A((f₁²+f₂²)^{0.5}) is the visual contrast sensitivity function for first and second frequencies of halftone dots in the patch, the first and second frequencies being computed in first and second directions.

8. The system of claim 7, wherein the visual contrast sensitivity function is expressed in the general form:
$$A ( {( {f}_{1}^{2} + {f}_{2}^{2} )}^{0.5} ) = x ( γ + {z ( {f}_{1}^{2} + {f}_{2}^{2} )}^{0.5} {exp}^{- {( {z ( {f}_{1}^{2} + {f}_{2}^{2} )}^{0.5} )}^{n}} ,$$
or a function thereof, where x, y, z and n are each values greater than 0.

9. The system of claim 1, further comprising instructions for generating a color profile from the total colorant limit for the first print media.

10. The system of claim 1, wherein the determining of the total colorant limit for the first print media comprises fitting a Gaussian mixture function to the total colorant values and corresponding grain values for the printed patches in the set and identifying the total colorant limit from the Gaussian mixture function.

11. The system of claim 1, wherein the threshold grain value is determined from human observations.

12. A method for determining a total colorant limit for printing images, comprising:
printing a set of printed patches on selected print media, the set of printed patches including patches printed on the print media at different total colorant values;
determining a grain value for each of the printed patches in the set of printed patches, the grain value being based upon a visual contrast sensitivity function computed for the patch; and
determining a total colorant limit for the first print media, as a function of the total colorant values and corresponding grain values for the printed patches in the set, wherein the total colorant limit is a total colorant value which corresponds to a grain value which does not exceed a threshold grain value for the first print media.

13. The method of claim 12, further comprising:
receiving a print job to be printed, the print job including at least one page image; and
computing colorant values for printing pixels of the at least one page image, wherein the colorant values are computed such that they do not exceed the total colorant value.

14. The method of claim 13, further comprising generating a color profile based on the total colorant limit for the first print media and wherein the computing colorant values is performed with the color profile.

15. The method of claim 12, wherein the determining of the grain value for each of the printed patches in the set of printed patches is performed on a captured image of the printed test patches.

16. The method of claim 12, wherein the determining of the grain value comprises computing an integrated function of the visual contrast sensitivity function computed for a respective pair of frequency components determined for the test patch, each frequency component in a pair representing a frequency of halftone dots in a respective direction.

17. The method of claim 16, wherein the integrated function is also a function of a lightness of the respective patch.

18. The method of claim 12, wherein the determining of the grain value comprises computing a grain value according to:
Grain value of patch
$$G = {\{ {\sum }_{f 1} {\sum }_{f 2} {[ {patch}_{fft ( f 1 , f 2 )} * A ( {( {f}_{1}^{2} + {f}_{2}^{2} )}^{0.5} ) ]}^{2} \}}^{0.5} ,$$
where patch_{fft(f1,f2)} is a fast Fourier transform (fft) of pairs of first and second frequency components for dots in the patch and A((f₁²+f₂²)_{0.5}) is the visual contrast sensitivity function for a pair of the first and second frequency components, the first and second frequency components being computed in first and second directions; and
where the visual contrast sensitivity function is expressed in the general form:
$$A ( {( {f}_{1}^{2} + {f}_{2}^{2} )}^{0.5} ) = x ( y + {z ( {f}_{1}^{2} + {f}_{2}^{2} )}^{0.5} {exp}^{- {( {z ( {f}_{1}^{2} + {f}_{2}^{2} )}^{0.5} )}^{n}} ,$$
or a function thereof,
where x, y, z and n are each values greater than 0.

19. The method of claim 13, wherein the threshold grain value is determined from human observations.

20. A system for applying a total colorant limit for printing images, comprising:
an inkjet printer comprising a plurality of colorant stations, each of the colorant stations applying a respective colorant to print media in accordance with printing instructions;
a computing device in communication with the printer which computes a total colorant limit for the plurality of colorant stations as a function of a computed grain value for each of a set of test patches printed on the print media by the colorant stations.
